(19) United States
(12) Patent Application Publication
(10) Pub. No.: US 2020/0244721 A1
(43) Pub. Date: Jul. 30, 2020

(54) DEPLOYING A WORKLOAD

(71) Applicant: Hewlett Packard Enterprise Development LP, Houston, TX (US)

(72) Inventors: Lokesh S, Bangalore (IN); Kiran Kumar Vaddi, Bangalore (IN); Vikas D M, Bangalore (IN)

(21) Appl. No.: 16/262,219

(22) Filed: Jan. 30, 2019

(51) Int. Cl. H04L 29/08; H04L 12/66; H04L 12/46; H04L 29/06

(52) U.S. Cl. CPC H04L 67/10; H04L 12/66; H04L 12/4641; H04L 63/0428; H04L 67/18; H04L 63/0272; H04L 12/4633

(57) ABSTRACT

Example implementations relate to deploying a workload. A computing device may comprise a processing resource and a memory resource storing non-transitory machine-readable instructions to cause the processing resource to receive a workload request, where the workload request includes a requested geographic location to deploy a workload, and deploy the workload on a worker node via a plugin in the requested geographic location, where the computing device is in a different geographic location than the worker node.

### BACKGROUND

Pooled computing resources and/or other services may be provisioned in order to deploy workloads. Pooled computing resources may be utilized to deploy a particular workload requested by a client. For instance, computing resources in a cloud infrastructure, private data center, and/or bare metal servers may be utilized to deploy a particular workload, among other computing resource environments.

### BRIEF DESCRIPTION OF THE DRAWINGS

FIG. 1 illustrates an example system consistent with the disclosure.

FIG. 2 illustrates an example system consistent with the disclosure.

FIG. 3 is a block diagram of an example computing device for deploying a workload consistent with the disclosure.

FIG. 4 is a block diagram of an example system consistent with the disclosure.

FIG. 5 illustrates an example method consistent with the disclosure.

### DETAILED DESCRIPTION

Pooled computing resources may be operated by an orchestration agent. For example, an orchestration agent can perform deployment, scaling, and/or management services to various types of pooled computing resources. Users of pooled computing resources may utilize pooled computing resources to perform various computing tasks, allowing for users to avoid or lessen computing infrastructure and maintenance costs, among other reasons.

Clusters of pooled computing resources may be created in same availability zones. For example, a pool of computing resources may be created/operated in an availability zone on a cloud service (e.g., public, private, and/or hybrid cloud service) or on a same data center.

However, creating/operating a pool of computing resources in a same availability zone may prevent a user who may be remotely located geographically from the pool of computing resources from deploying a workload on the remotely located pool of computing resources. For example, a user located in the United States may wish to deploy a workload on a pool of computing resources located in India. Since the pool of computing resources are located in the same availability zone (e.g., India), it may not be feasible for the user located in the United States to deploy the workload using the pooled computing resources in India.

Deploying a workload, according to the disclosure, can allow for deployment of a workload in a particular geographic location. The workload may be deployed in a location that is geographically different than the availability zone of the pooled computing resources. For example, the workload can be deployed without regard to the availability zone of a pool of computing resources. Accordingly, a user may deploy a workload in a desired geographic location.

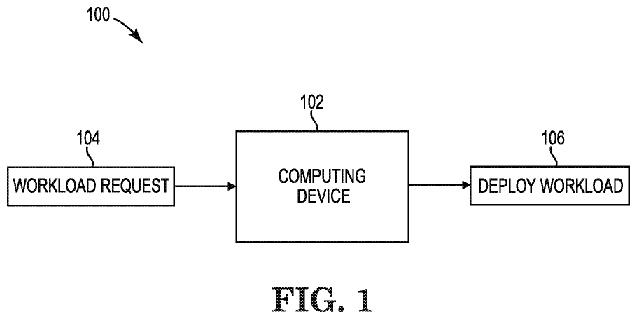

FIG. 1 illustrates an example system 100 consistent with the disclosure. As illustrated in FIG. 1, the system 100 can include computing device 102, workload request 104, and deploy workload 106.

System 100 can include computing device 102. As used herein, the term “computing device” can, for example, refer to a device including a processor, memory, and input/output interfaces for wired and/or wireless communication. A computing device may include a laptop computer, a desktop computer, a mobile device, and/or other wireless devices, although examples of the disclosure are not limited to such devices. A mobile device may refer to devices that are (or may be) carried and/or worn by a user. For instance, a mobile device can be a phone (e.g., a smart phone), a tablet, a personal digital assistant (PDA), smart glasses, and/or a wrist-worn device (e.g., a smart watch), among other types of mobile devices.

Computing device 102 can be utilized for deploying a workload. For example, computing device 102 can be utilized to receive a workload request 104 and deploy the workload 106, as is further described herein. As used herein, the term “workload” can, for example, refer to a set of instructions that are executed by a processor to perform a task. For example, the workload can be a set of non-transitory machine-readable instructions that are executed by a processor to perform a coordinated function, task, and/or activity, as is further described herein. As used herein, the term “workload request” can, for example, refer to a message sent between two computing devices asking for a particular action. For example, a workload request 104 can be a message sent from a user computing device to computing device 102 asking computing device 102 to perform a particular action, as is further described herein.

Computing device 102 can be a node. As used herein, the term “node” can, for example, refer to a device on a larger network. For example, computing device 102 can be a computing device that is connected to other computing devices on a larger network. Computing device 102 can be a master node among other nodes on the larger network. As used herein, the term “master node” can, for example, refer to a governing node among other nodes on a larger network. For example, computing device 102 can govern actions taken by other computing devices on a larger network.

In some examples, computing device 102 can be a master node in a Kubernetes cluster. For example, as described above, orchestration systems such as Kubernetes may perform deployment, scaling, and/or other management services. Computing device 102 may be a master node in a Kubernetes cluster environment to perform deployment, scaling and/or other management services for other nodes in the pooled computing resource environment.

Although computing device 102 is described above as being a master node in a Kubernetes cluster, examples of the disclosure are not so limited. For example, computing device 102 can be a master node utilized by any other orchestration agent in a pooled computing resource environment.

Computing device 102 can receive a workload request 104. For example, a user may desire to deploy a workload, and can request computing device 102 to deploy the workload 106. In other words, the workload request 104 can be associated with a workload. Accordingly, computing device 102 can receive a workload request 104 from a user to deploy a particular workload. As used herein, the term “worker node” can, for example, refer to a node governed by a master node.

In some examples, the workload can be a web application. As used herein, the term “web application” can, for example, refer to a software application that runs on a remote server. For example, a web application can be a set of instructions that are executed by a processor on a remote server to perform a task.

Although the workload is described above as being a web application, examples of the disclosure are not so limited. For example, the workload can be any other type of workload.

Computing device 102 can receive the workload request 104 from a user. The workload request 104 can include a requested geographic location to deploy the workload 106. As used herein, the term “geographic location” refers to a physical place on the Earth occupied by a worker node. For example, the user can specify the load be deployed in the United States and send a workload request 104 to computing device 102, which may be a master node located on a pool of computing resources (e.g., a Kubernetes cluster, among other examples) located in India. The pool of computing resources can be a public cloud, datacenter, and/or bare metal server, among other examples, as is further described herein.

The requested geographic location can be a same location as a geographic location of the worker node. That is, a user may desire to deploy a workload in the United States utilizing the pool of computing resources located in India and send a workload request 104 having a requested geographic location of the United States.

In response to the workload request 104, computing device 102 can create a worker node. In some examples, the worker node can be a virtual machine (VM). As used herein, the term “virtual machine” can, for example, refer to an emulation of a physical computing device. For example, computing device 102 can create an emulation of a physical computing device on the worker node. In some examples, computing device 102 can create the VM utilizing Amazon Web Services, Azure, Google Cloud Products, etc.

Although the worker node is described above as being a VM, examples of the disclosure are not so limited. For example, the worker node can be a bare metal server, laptop computing device, desktop computing device, raspberry pi, among other types of virtual and/or physical computing devices.

Computing device 102 can deploy the workload 106 via a plugin on the worker node. For example, the worker node can be utilized to deploy a workload (e.g., a web application). The worker node can be located in the requested geographic location. Accordingly, the workload can be deployed via the plugin on the worker node in the different geographic location than computing device 102. As used herein, the term “plugin” can, for example, refer to a software component that adds a feature to an existing computer program. For example, computing device 102 can deploy a workload to a worker node using an added feature of a computer program.

Computing device 102 can deploy the workload 106 on a worker node located in the different geographic location via a virtual network gateway. As used herein, the term “virtual network gateway” can, for example, refer to a pathway used to send traffic between two computing devices. For example, the virtual network gateway can be a virtual private network (VPN) tunnel. As used herein, the term “VPN” can, for example, refer to an extension of a private network across a public network. As used herein, the term “VPN tunnel” can, for example, refer to an encrypted communication pathway between two computing devices. For example, computing device 102 can communicate with a worker node via the VPN tunnel. Computing device 102 can communicate with the worker node via the VPN tunnel to deploy the workload 106.

In some examples, computing device 102 can be located in a data center. As used herein, the term “data center” can, for example, refer to a space housing computer systems and/or associated components, such as telecommunications and/or storage systems which may be utilized as pooled computing resources. For example, a user can request a workload be deployed in a location that may be remotely located (e.g., in the United States) from a data center (e.g., being on an availability zone in India), but the user may desire to deploy a workload utilizing the data center located in India. Computing device 102 can deploy the workload on the worker node in the requested geographic location by communicating with the worker node located remotely from the data center through a VPN tunnel.

In some examples, computing device 102 can be located in a first public cloud and the worker node located in a second public cloud. As used herein, the term “data center” can, for example, refer to pooled computing resources offered over public Internet. For example, a user can request a workload be deployed in a location that may be remotely located (e.g., in the United States) from a public cloud (e.g., being on an availability zone in India), but the user may desire to deploy a workload utilizing the public cloud located in India. Computing device 102 can deploy the workload on the worker node in the requested geographic location by communicating with the worker node located remotely from the public cloud through a VPN tunnel. The worker node can communicate with computing device 102 through the VPN tunnel via a VPN gateway included in the first public cloud. As used herein, the term “VPN gateway” can, for example, refer to a virtual network gateway used to send traffic between a virtual computing device and another computing device.

In some examples, computing device 102 can be located in a bare metal server. As used herein, the term “bare metal server” can, for example, refer to a physical server dedicated to a single tenant. For example, a user can request a workload be deployed in a location that may be remotely located (e.g., in the United States) from the bare metal server (e.g., located in India), but the user may desire to deploy a workload utilizing the bare metal server located in India. Computing device 102 can deploy the workload on the worker node in the requested geographic location by communicating with the worker node located remotely from the bare metal server through a VPN tunnel.

By deploying the workload 106, the worker node can execute the workload. For example, the workload can be a web application, and the worker node can execute the web application utilizing the encrypted VPN tunnel while the worker node is located remotely from the computing device 102.

Deploying a workload, according to the disclosure, can provide an ability to deploy workloads remotely via a worker node from a set of computing resources. The worker node can be created to allow the workload to be deployed in a user specified location remote from the set of computing resources without latency issues.

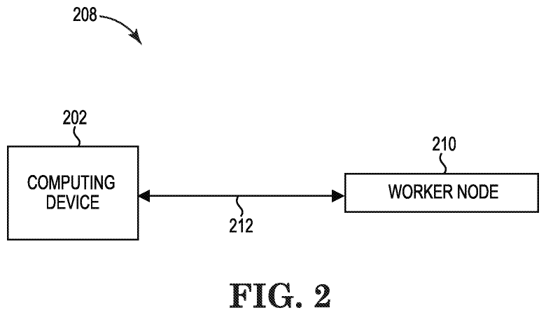

FIG. 2 illustrates an example system 208 consistent with the disclosure. As illustrated in FIG. 2, the system 208 can include computing device 202, worker node 210, and VPN tunnel 212.

As previously described in connection with FIG. 1, in some examples computing device 202 can be located in a data center. For example, computing device 202 can be a master node located in a data center and can communicate with worker node 210 to deploy a workload via a plugin on a VM located on worker node 210 via VPN tunnel 212. Although not illustrated in FIG. 2 for clarity and so as not to obscure examples of the disclosure, the data center can include computing device 202 and an orchestration agent. The computing device 202 can communicate with worker node 210 through VPN tunnel 212 via a router. Further, although not shown in FIG. 2 for clarity, worker node 210 can communicate with computing device 202 through VPN tunnel 212 via a different router.

Further, as previously described in connection with FIG. 1, in some examples computing device 202 can be located in a public cloud. For example, computing device 202 can be a master node located in a public cloud and can communicate with worker node 210 (e.g., located in a different cloud) to deploy a workload via a plugin on a worker node 210 via VPN tunnel 212. Although not illustrated in FIG. 2 for clarity and so as not to obscure examples of the disclosure, the public cloud including computing device 202 can include a VPN gateway and an orchestration agent. The computing device 202 can communicate with worker node 210 through VPN tunnel 212 via the VPN gateway. Further, although not shown in FIG. 2 for clarity, worker node 210 can communicate with computing device 202 through VPN tunnel 212 via a server.

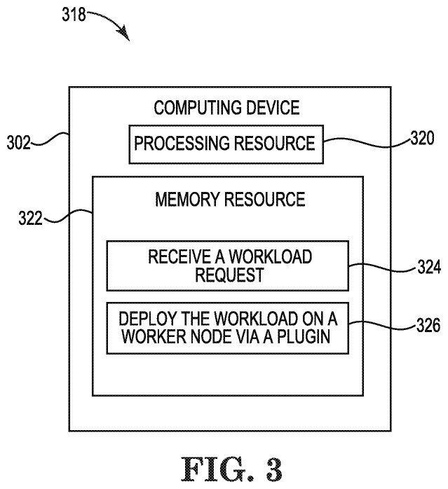

FIG. 3 is a block diagram 318 of an example computing device 302 for deploying a workload consistent with the disclosure. As described herein, the computing device 302 may perform a number of functions related to deploying a workload. Although not illustrated in FIG. 3, the computing device 302 may include a processor and a machine-readable storage medium. Although the following descriptions refer to a single processor and a single machine-readable storage medium, the descriptions may also apply to a system with multiple processors and multiple machine-readable storage mediums. In such examples, the computing device 302 may be distributed across multiple machine-readable storage mediums and the computing device 302 may be distributed across multiple processors. Put another way, the instructions executed by the computing device 302 may be stored across multiple machine-readable storage mediums and executed across multiple processors, such as in a distributed or virtual computing environment.

As illustrated in FIG. 3, the computing device 302 may comprise a processing resource 320, and a memory resource 322 storing machine-readable instructions to cause the processing resource 320 to perform a number of operations related to deploying a workload. That is, using the processing resource 320 and the memory resource 322, the computing device 302 may deploy a workload, among other operations. Processing resource 320 may be a central processing unit (CPU), microprocessor, and/or other hardware device suitable for retrieval and execution of instructions stored in memory resource 322.

The computing device 302 may include instructions 324 stored in the memory resource 322 and executable by the processing resource 320 to receive a workload request. Computing device 302 can be a master node and can receive the workload request to deploy a workload associated with the workload request. The workload request can include a requested geographic location to deploy the workload. The requested geographic location can be a different geographic location than the geographic location of computing device 302.

The computing device 302 may include instructions 326 stored in the memory resource 322 and executable by the processing resource 320 to deploy the workload on a worker node via a plugin. The computing device 302 can deploy the workload via the plugin on a worker node located in the requested geographic location included in the workload request. For example, computing device 302 can deploy the workload on a worker node that may be geographically remotely located from computing device 302. Computing device 302 can communicate with the worker node via a VPN tunnel. In this manner, computing device 302 can deploy a workload.

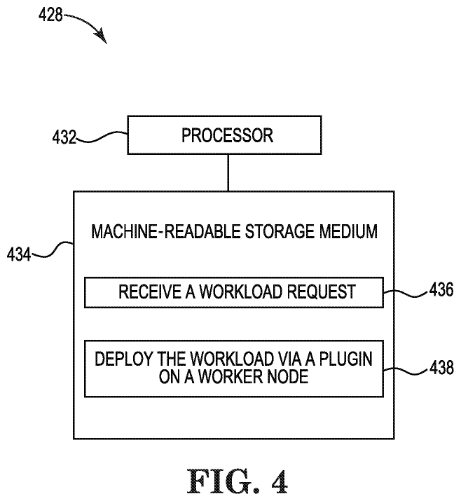

FIG. 4 is a block diagram of an example system 428 consistent with the disclosure. In the example of FIG. 4, system 428 includes a processor 432 and a machine-readable storage medium 434. Although the following descriptions refer to a single processor and a single machine-readable storage medium, the descriptions may also apply to a system with multiple processors and multiple machine-readable storage mediums. In such examples, the instructions may be distributed across multiple machine-readable storage mediums and the instructions may be distributed across multiple processors. Put another way, the instructions may be stored across multiple machine-readable storage mediums and executed across multiple processors, such as in a distributed computing environment.

Processor 432 may be a central processing unit (CPU), microprocessor, and/or other hardware device suitable for retrieval and execution of instructions stored in machine-readable storage medium 434. In the particular example shown in FIG. 4, processor 432 may receive, determine, and send instructions 436 and 438. As an alternative or in addition to retrieving and executing instructions, processor 432 may include an electronic circuit comprising a number of electronic components for performing the operations of the instructions in machine-readable storage medium 434. With respect to the executable instruction representations or boxes described and shown herein, it should be understood that part or all of the executable instructions and/or electronic circuits included within one box may be included in a different box shown in the figures or in a different box not shown.

Machine-readable storage medium 434 may be any electronic, magnetic, optical, or other physical storage device that stores executable instructions. Thus, machine-readable storage medium 434 may be, for example, Random Access Memory (RAM), an Electrically-Erasable Programmable Read-Only Memory (EEPROM), a storage drive, an optical disc, and the like. The executable instructions may be “installed” on the system 428 illustrated in FIG. 4. Machine-readable storage medium 434 may be a portable, external or remote storage medium, for example, that allows the system 428 to download the instructions from the portable/external/remote storage medium. In this situation, the executable instructions may be part of an “installation package”. As described herein, machine-readable storage medium 434 may be encoded with executable instructions for deploying a workload.

Receive instructions 436, when executed by a processor such as processor 432, may cause system 428 to receive a workload request. For example, system 428 can be a master node and can receive the workload request to deploy a workload associated with the workload request. The workload request can include a requested geographic location to deploy the workload. The requested geographic location can be a different geographic location than the geographic location of system 428.

Deploy instructions 438, when executed by a processor such as processor 432, may cause system 428 to deploy the workload via a plugin on a worker node. That is, system 428 can deploy the workload via the worker node in the requested geographic location included in the workload request. For example, system 428 can deploy the workload on a worker node that may be geographically remotely located from system 428. System 428 can communicate with the worker node via a VPN tunnel. In some examples, the worker node can be a VM, a bare metal server, laptop computing device, desktop computing device, raspberry pi, among other types of computing devices.

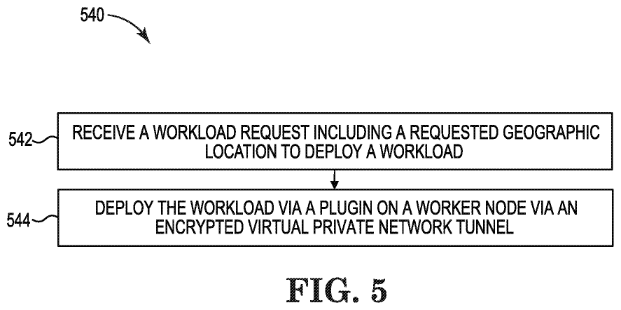

FIG. 5 illustrates an example method 540 consistent with the disclosure. Method 540 may be performed, for example, by a computing device (e.g., computing device 102, 202, 302, previously described in connection with FIGS. 1, 2, and 3, respectively).

At 542, the method 540 may include receiving a workload request including a requested geographic location to deploy a workload. The workload request can be associated with the workload. The computing device can, in some examples, be a master node included in a computing resource environment (e.g., a Kubernetes cluster, among other examples). The requested geographic location to deploy the workload can be a different geographic location than the geographic location of the computing device.

At 544, the method 540 may include deploying the workload via a plugin on a worker node via an encrypted VPN tunnel. For example, the computing device can create a worker node, where the worker node is located in a different geographic location than the computing device/master node. The computing device can communicate with the worker node to deploy the workload via the encrypted VPN tunnel. In some examples, the worker node can be a VM, a bare metal server, laptop computing device, desktop computing device, raspberry pi, among other types of computing devices. In some examples, the worker node can be a user's computing device (e.g., the user who sent the workload request to the computing device to deploy the workload), a VM. In some examples, the worker node can be located remotely from the computing device and from a user who sent the workload request to the computing device to deploy the workload (e.g., the worker node can be located on a cloud computing environment).

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure.

The figures herein follow a numbering convention in which the first digit corresponds to the drawing figure number and the remaining digits identify an element or component in the drawing. Similar elements or components between different figures may be identified by the use of similar digits. For example, 102 may reference element “02” in FIG. 1, and a similar element may be referenced as 202 in FIG. 2. Elements shown in the various figures herein can be added, exchanged, and/or eliminated so as to provide a plurality of additional examples of the disclosure. In addition, the proportion and the relative scale of the elements provided in the figures are intended to illustrate the examples of the disclosure, and should not be taken in a limiting sense. As used herein, “a plurality of” an element and/or feature can refer to more than one of such elements and/or features.

What is claimed:

1. A computing device, comprising:
a processing resource; and
a memory resource storing non-transitory machine-readable instructions to cause the processing resource to:
receive a workload request, wherein the workload request includes a requested geographic location to deploy a workload; and
deploy the workload on a worker node via a plugin in the requested geographic location, wherein the computing device is in a different geographic location than the worker node.

2. The computing device of claim 1, including instructions to cause the processing resource to deploy the workload via the plugin in the different geographic location via a virtual network gateway.

3. The computing device of claim 1, wherein the computing device is a master node.

4. The computing device of claim 1, including instructions to cause the processing resource to deploy the workload on the worker node.

5. The computing device of claim 1, wherein the computing device is located in a data center and the worker node is located remotely from the data center.

6. The computing device of claim 5, including instructions to cause the processing resource to communicate with the worker node located remotely from the data center through a virtual private network (VPN) tunnel.

7. The computing device of claim 1, wherein the computing device is located in a first public cloud and the worker node is located in a second public cloud.

8. The computing device of claim 7, including instructions to cause the processing resource to communicate with the worker node located in the second public cloud via a virtual private network (VPN) tunnel.

9. The computing device of claim 8, wherein the worker node communicates with the computing device through the VPN tunnel via a VPN gateway included in the first public cloud.

10. The computing device of claim 8, wherein the VPN tunnel is an encrypted VPN tunnel.

11. The computing device of claim 1, wherein the computing device is located in a bare metal server and the worker node is located remotely from the data center.

12. A non-transitory computer readable medium storing instructions executable by a processing resource to cause the processing resource to:
receive a workload request, wherein the workload request includes a requested geographic location to deploy a workload; and
deploy the workload via a plugin on a worker node in the requested geographic location via a virtual private network (VPN) tunnel, wherein the computing device is in a different geographic location than the worker node.

13. The medium of claim 12, wherein the workload is associated with the workload request.

14. The medium of claim 12, wherein the requested geographic location is a same location as a geographic location of the worker node.

15. The medium of claim 12, comprising instructions to create the worker node in response to the workload request.

16. The medium of claim 12, comprising instructions to receive the workload request from the worker node.

17. A method, comprising:
receiving, by a master node, a workload request, wherein the workload request includes a requested geographic location to deploy a workload associated with the workload request;
deploying, by the master node, the workload via a plugin on a worker node via an encrypted virtual private network (VPN) tunnel, wherein:
the worker node is located in the requested geographic location; and
the requested geographic location is in a different geographic location than the master node.

18. The method of claim 17, wherein the method includes communicating, by the master node with the worker node, via the encrypted VPN tunnel.

19. The method of claim 17, wherein the method includes executing, by the worker node, the workload.

20. The method of claim 19, wherein:
the workload is a web application; and
the method includes deploying the web application on the worker node via the encrypted VPN tunnel.
